(19) United States
(12) Patent Application Publication
(10) Pub. No.: US 2009/0281226 A1
(43) Pub. Date: Nov. 12, 2009

(54) PROCESS FOR MAKING NANOCOMPOSITES

(76) Inventor: SURBHI MAHAJAN, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/115,721

(22) Filed: May 6, 2008

(51) Int. Cl. C08K 3/34

(52) U.S. Cl. 524/446

(57) ABSTRACT

A method for making poly(ether-ester) and poly(butylene terephthalate) nanocomposite materials by polymerization in the presence of exfoliated fibrous clay nanoparticles includes dispersing the nanoparticles in a mixture of diol and water before polymerization, thereby improving the dispersion of the nanoparticles in the final nanocomposite. This results in enhanced mechanical properties, such as modulus, in articles made from the nanocomposite.

### FIELD OF THE INVENTION

The disclosure relates to methods of forming poly(ether-ester) nanocomposites comprising a fibrous clay nanofiller and a poly(ether-ester).

### BACKGROUND

Nanocomposites are polymers reinforced with nanometer sized particles, i.e., particles with a dimension on the order of 1 to several hundred nanometers, herein referred to as “nanoparticles.”

Polymer-layered silicate nanocomposites incorporate a layered clay mineral filler in a polymer matrix. Layered silicates are made up of several hundred thin platelet layers stacked into an orderly packet known as a tactoid. Each of these platelets is characterized by a large aspect ratio (diameter/thickness on the order of 100-1000). Accordingly, when the clay is dispersed homogeneously and exfoliated as individual platelets throughout the polymer matrix, dramatic increases in strength, flexural and Young's modulus, and heat distortion temperature are observed at very low filler loadings (<10% by weight) because of the large surface area contact between polymer and filler. Two types of clay minerals are commonly used in nanocomposites: kaolin and smectite. The molecules of kaolin are arranged in two sheets or platelets, one of silica and one of alumina. Smectites, such as sodium montmorillonite and calcium montmorillonite, are arranged in two silica sheets and one alumina sheet. In contrast, fibrous clay particles are made up of aggregates of fibers or ribbons, not sheets or platelets.

In PCT Patent Application WO 2006/069128, herein incorporated by reference in its entirety, a polyester nanocomposite is prepared via in situ polymerization of the polyester precursor(s) in the presence of exfoliated fibrous clay nanoparticles. As used therein, the term “polyester” means a condensation polymer in which more than 50 percent of the groups connecting repeat units are ester groups. Thus polyesters may include polyesters, poly(ester-amides), poly(ester-imides), poly(ether-esters), and the like, so long as more than half of the connecting groups are ester groups.

H.-C. zur Loye et al., in PCT Application WO2006012581, disclose a process for exfoliating particles into a polymer material wherein the step of combining synthetic oxide particles with a polymeric material comprises the steps of: exfoliating the particles into a monomer; and polymerizing the monomer to form a polymer composite material. Useful synthetic oxides include any synthetic oxides that have a plate-like shape with a thickness of less than about 5 nm and that are capable of being exfoliated into a polymer. Examples are synthetic hectorite and layered perovskites. During exfoliation, the object is to break many layers apart so as to form single layer particles or particles that have only a few layers, which are referred to as tactoids. In one embodiment, this is accomplished by applying shear forces to a solution of up to 5 wt % synthetic oxide particles in ethylene glycol and using the resulting suspension with additional monomers in a polyester polymerization process.

There remains a need for an improved process for preparing a polymer nanocomposite via in situ polymerization with improved dispersion of the nanofiller in order to enhance improvement in properties such as tensile strength and modulus.

### SUMMARY OF THE INVENTION

The invention is directed to a method for dispersing exfoliated fibrous clay nanoparticles in a poly(ether-ester) having a multiplicity of recurring long-chain ester units and short-chain ester units joined head-to-tail through ester linkages, said long-chain ester units being represented by Formula I

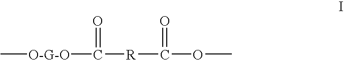

and said short-chain ester units being represented by Formula II

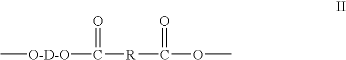

wherein G is a divalent radical remaining after the removal of terminal hydroxyl groups from a poly(alkylene oxide)glycol having an average molecular weight of about 400-3500;
R is a divalent radical remaining after removal of carboxyl groups from a dicarboxylic acid having a molecular weight less than about 300; and
D is a divalent radical remaining after removal of hydroxyl groups from a diol having a molecular weight less than about 250;
wherein said poly(ether-ester) contains from about 25 to about 90 weight percent short-chain ester units, based upon the total weight of the poly(ether-ester), comprising:
a. providing a mixture of exfoliated fibrous clay nanoparticles, HO-D-OH and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in HO-D-OH and the remaining water;
d. preparing a reaction mixture by mixing the slurry produced in (c) with polyalkylene glycol OH-G-OH; the dicarboxylic acid

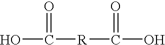

or the dimethyl ester thereof,

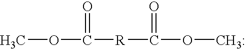

and additional HO-D-OH as needed for the polymerization; and
e. polymerizing the reaction mixture prepared in (d) in the presence of a catalyst.

The invention is further directed to a method for dispersing exfoliated fibrous clay nanoparticles in poly(butylene terephthalate),

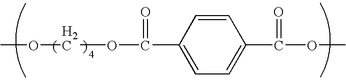

comprising
a. providing a mixture of exfoliated fibrous clay nanoparticles, 1,4-butanediol and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in 1,4-butanediol and the remaining water;
d. preparing a reaction mixture by mixing the slurry produced in (c) with dimethyl terephthalate or terephthalic acid and with additional 1,4-butanediol as needed for the polymerization; and
e. polymerizing the reaction mixture prepared in (d) in the presence of a catalyst.

### BRIEF DESCRIPTION OF THE DRAWINGS

FIG. 1 is a transmission electron micrograph of a mixture of water, 1,4-butanediol, and Pangel® S-9 sepiolite as prepared and also a transmission electron micrograph of the slurry of 1,4-butanediol, residual water, and Pangel® S-9 sepiolite after agitation and distillation.

FIG. 2 is a bright field transmission electron micrograph of the poly(ether-ester)/sepiolite nanocomposite made in Example 1, as made.

FIG. 3 is a bright field transmission electron micrograph of the poly(ether-ester)/sepiolite nanocomposite after extrusion (Example 2).

FIG. 4 is a bright field transmission electron micrograph of the poly(ether-ester)/sepiolite nanocomposite made in Comparative Example A, without predispersion of sepiolite nanoparticles in butanediol/water, as made.

FIG. 5: is a bright field transmission electron micrograph of the poly(ether-ester)/sepiolite nanocomposite made in Comparative Example A, without predispersion of sepiolite nanoparticles in butanediol/water, after extrusion.

FIG. 6 is a representation of storage modulus data for poly(ether-ester) polymer and nanocomposites over a temperature range of −100° C. to 150° C.

FIG. 7 is a representation of tan δ verses temperature behavior for poly(ether-ester) polymer and nanocomposites.

FIG. 8 is a bright field TEM micrograph of the poly(ether-ester)/sepiolite nanocomposite made in Example 5, as-made.

FIG. 9 is a bright field TEM micrograph of the poly(ether-ester)/sepiolite nanocomposite made in Example 5, after extrusion.

FIG. 10: is a bright field transmission electron micrograph of the poly(ether-ester)/sepiolite nanocomposite made in Comparative Example B, without predispersion of sepiolite nanoparticles in butanediol/water, as made.

FIG. 11: is a bright field transmission electron micrograph of the poly(ether-ester)/sepiolite nanocomposite made in Comparative Example B, without predispersion of sepiolite nanoparticles in butanediol/water, after extrusion.

FIG. 12 shows bright field transmission electron micrographs of the poly(butylene terephthalate)/sepiolite nanocomposites prepared with (Example 7) and without (Comparative Example C) predispersing the sepiolite nanoparticles in a 1,4-butanediol/water mixture.

FIG. 13 shows bright field transmission electron micrographs of poly(ethylene terephthalate)/sepiolite nanocomposites prepared with (Comparative Example E) and without predispersing the sepiolite in a 1,4-butanediol/water mixture.

### DETAILED DESCRIPTION

In the context of this disclosure, a number of terms shall be utilized.

As used herein, the term “poly(ether-ester)” includes polyesters that incorporate residues of poly(alkylene ether) glycols, such as poly(ethylene ether glycol), poly(trimethylene ether glycol), poly(tetramethylene ether)glycol, in the polymer chain.

As used herein, the term “nanocomposite” or “polymer nanocomposite” means a polymeric material which contains “nanoparticles” (i.e., particles having at least one dimension in the 0.1 to 100 nm range) dispersed throughout the polymeric material. The polymeric material in which the nanoparticles are dispersed is often referred to as the “polymer matrix.” The term “poly(ether-ester) composite” refers to a nanocomposite in which the polymeric material includes at least one poly(ether-ester).

As used herein, the term “fibrous clay” refers to both sepiolite clay and attapulgite (palygorskite) clay, as well as mixtures thereof.

The term “exfoliate” literally refers to casting off in scales, laminae, or splinters, or to spread or extend by or as if by opening out leaves. In the case of smectic clays, “exfoliation” refers to the separation of platelets from the smectic clay and subsequent dispersion of these platelets throughout the polymer matrix. As used herein, for fibrous clays, “exfoliation” or “exfoliated” means the separation of fiber bundles or aggregates into nanoparticles, which are nanometer diameter fibers. These exfoliated fibrous clay nanoparticles, also referred to more concisely as “fibrous clay nanoparticles” or, for specific exfoliated fibrous clays, “sepiolite nanoparticles” or “attapulgite nanoparticles,” that are then dispersed throughout the polymer matrix.

As used herein, the term “long-chain ester units” as applied to units in a polymer chain refers to the reaction product of a long-chain glycol with a dicarboxylic acid.

As used herein, the term “short-chain ester units” as applied to units in a polymer chain of the poly(ether-esters) refers to the reaction product of a low molecular weight diol (MW below about 250) with a dicarboxylic acid.

As used herein, the term “predispersed” or “predispersion” indicates that the exfoliated fibrous clay nanoparticles are dispersed in the specified water/short-chain diol mixture before being added to the polymerization reaction mixture.

Described herein is a method for dispersing exfoliated fibrous clay nanoparticles in a poly(ether-ester) having a multiplicity of recurring long-chain ester units and short-chain ester units joined head-to-tail through ester linkages, said long-chain ester units being represented by Formula I

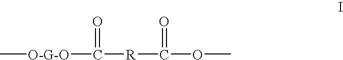

and said short-chain ester units being represented by Formula II

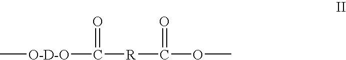

wherein G is a divalent radical remaining after the removal of terminal hydroxyl groups from a poly(alkylene oxide) glycol having an average molecular weight of about 400-3500;
R is a divalent radical remaining after removal of carboxyl groups from a dicarboxylic acid having a molecular weight less than about 300; and
D is a divalent radical remaining after removal of hydroxyl groups from a diol having a molecular weight less than about 250;
wherein said poly(ether-ester) contains from about 25 to about 90 weight percent short-chain ester units, based upon the total weight of the poly(ether-ester), comprising:
a. providing a mixture of exfoliated fibrous clay nanoparticles, HO-D-OH and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in HO-D-OH and the remaining water;
d. preparing a reaction mixture by mixing the slurry produced in (c) with polyalkylene glycol OH-G-OH; the dicarboxylic acid

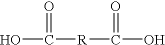

or the dimethyl ester thereof,

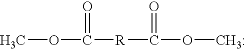

and additional HO-D-OH as needed for the polymerization; and
e. polymerizing the reaction mixture prepared in (d) in the presence of a catalyst.
   Also described herein is a method for dispersing exfoliated fibrous clay nanoparticles in poly(butylene terephthalate),

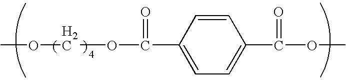

comprising
a. providing a mixture of exfoliated fibrous clay nanoparticles, 1,4-butanediol, and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in 1,4-butanediol and the remaining water;
d. preparing a reaction mixture by mixing the slurry produced in (c) with dimethyl terephthalate or terephthalic acid and with additional 1,4-butanediol as needed for the polymerization; and
e. polymerizing the reaction mixture prepared in (d) in the presence of a catalyst.

Moldings prepared from such nanocomposites have higher modulus, particularly at elevated temperatures, than moldings prepared from nanocomposites of the same composition wherein the exfoliated fibrous clay nanoparticles were not predispersed in a mixture of 1,4,-butanediol and water.

Where a range of numerical values is recited herein, unless otherwise stated, the range is intended to include the endpoints thereof, and all integers and fractions within the range. It is not intended that the scope of the invention be limited to the specific values recited when defining a range.

### Nanocomposites

The method of preparation of nanocomposites described herein produces a nanocomposite in which dispersion is improved over previous methods, thereby improving mechanical properties such as tensile strength and modulus.

### Poly(Ether-Esters) and Poly(Butylene Terephthalate)

Poly(ether-esters) suitable for use in the described herein have a multiplicity of recurring long-chain ester units and short-chain ester units joined head-to-tail through ester linkages, said long-chain ester units being represented by Formula I

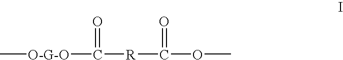

and said short-chain ester units being represented by Formula II

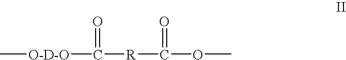

wherein G is a divalent radical remaining after the removal of terminal hydroxyl groups from a poly(alkylene oxide) glycol having an average molecular weight of about 400-3500;
R is a divalent radical remaining after removal of carboxyl groups from a dicarboxylic acid having a molecular weight less than about 300; and
D is a divalent radical remaining after removal of hydroxyl groups from a diol having a molecular weight less than about 250; and wherein said poly(ether-ester) contain from about 25 to about 90 weight percent short-chain ester units, based upon the total weight of the poly(ether-ester).

The term “long-chain ester units” refers to the reaction product of a long-chain glycol with a dicarboxylic acid to form ester units represented by Formula I above. Examples of suitable long-chain glycols are poly(alkylene oxide) glycols having terminal (or as nearly terminal as possible) hydroxyl groups and having a molecular weight of from about 400 to about 3500, particularly from about 600 to about 1500. Specific examples of useful poly(alkylene oxide) glycols include without limitation poly(ethylene ether) glycol, poly(tetramethylene ether) glycol, poly(tetramethylene-co-2-methyltetramethylene ether) glycol [derived from the copolymerization of tetrahydrofuran and 3-methyltetrahydrofuran], poly(ethylene-co-tetramethylene ether) glycol, and mixtures thereof.

The term “short-chain ester units” refers to low molecular weight compounds or polymer chain units having molecular weights less than about 550. They are made by reacting a low molecular weight diol or a mixture of diols (MW below about 250) with a dicarboxylic acid to form ester units represented by Formula II above. Examples of low molecular weight diols which react to form short-chain ester units suitable for use for preparing poly(ether-esters) include without limitation ethylene glycol, 1,3 propane diol, 1,4-butanediol, 2,2-dimethyl-1,3-propylene diol, and mixtures thereof; 1,3 propane diol and 1,4-butanediol are particularly suitable.

The term “dicarboxylic acids” includes acid equivalents of dicarboxylic acids having two functional carboxyl groups which perform substantially like dicarboxylic acids in reaction with glycols and diols in forming poly(ether-ester) polymers. These equivalents include esters and ester-forming derivatives, such as acid halides and anhydrides. The requirement that the molecular weight be less than about 300 pertains to the acid and not to its equivalent ester or ester-forming derivative. Examples of suitable dicarboxylic acids include without limitation terephthalic acid (i.e., R is p-phenylene), optionally with minor amounts of isophthalic acid (i.e., R is m-phenylene), e.g., <20 mol % isophthalic acid; and diesters thereof.

The poly(ether-esters) contain about 25-90 weight percent short-chain ester units corresponding to Formula II above, the remainder being long-chain ester units corresponding to Formula I above. When the poly(ether-esters) contain less than about 25 weight percent short-chain ester units, the crystallization rate becomes very slow and the poly(ether-ester) is tacky and difficult to handle. In one embodiment, the poly(ether-esters) are prepared from esters or mixtures of esters of terephthalic acid, 1,4-butanediol and poly(tetramethylene ether) glycol or ethylene oxide-capped polypropylene oxide glycol, or are prepared from an ester of terephthalic acid (e.g. dimethyl terephthalate), 1,4-butanediol and poly(ethylene oxide)glycol.

In one embodiment, the polymer matrix of the nanocomposite is not a poly(ether-ester) but instead poly(butylene terephthalate), “PBT,” which may be prepared from an ester of terephthalic acid (e.g. dimethyl terephthalate) and 1,4-butanediol.

### Fibrous Clays

### Sepiolite and Attapulgite

Sepiolite [Mg₄Si₆O₁₅(OH)₂.6(H₂O)] is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The α form is known to be long bundles of fibers and the β form is present as amorphous aggregates.

Attapulgite (also known as palygorskite) is almost structurally and chemically identical to sepiolite except that attapulgite has a slightly smaller unit cell. As used herein, the term “fibrous clay(s)” includes attapulgite clay, sepiolite clay and mixtures thereof.

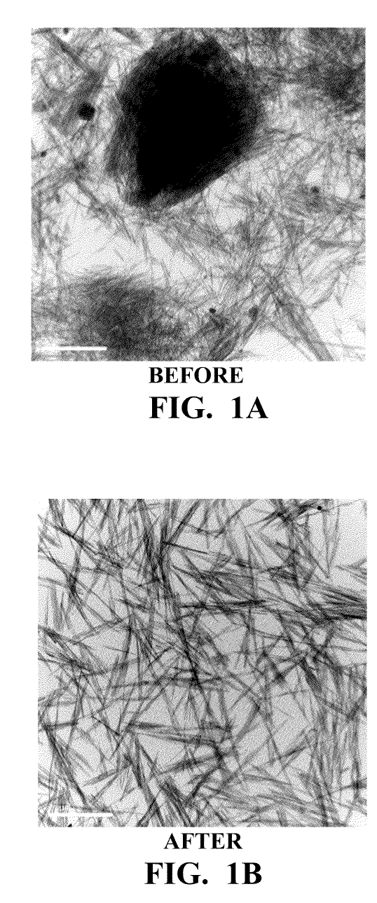

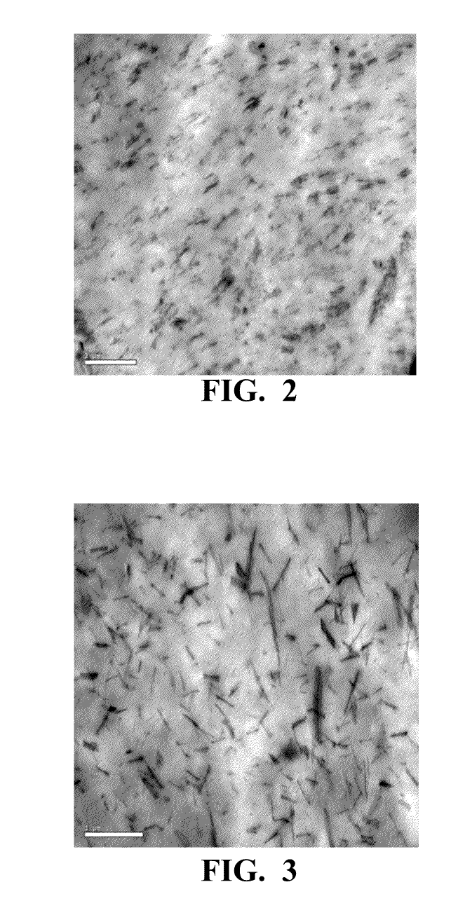

Fibrous clays are layered fibrous materials in which each layer is made up of two sheets of tetrahedral silica units bonded to a central sheet of octahedral units containing magnesium ions (see, e.g., FIGS. 1 and 2 in L. Bokobza et al., Polymer International, 53, 1060-1065 (2004)). The fibers stick together to form fiber bundles, which in turn can form agglomerates. These agglomerates can be broken apart by industrial processes such as micronization or chemical modification (see, e.g., European Patent 170,299 to Tolsa, S. A.) to produce nanometer diameter fibers, i.e., exfoliated fibrous clay nanoparticles.

The amount of fibrous clay used in the present process ranges from about 0.1 to about 35 wt % based on the final composite composition. The specific amount chosen will depend on the intended use of the nanocomposite, as is well understood in the art.

Fibrous clays are available in a high purity (“rheological grade”), uncoated form (e.g., PANGEL® S9 sepiolite clay from the Tolsa Group, Madrid, Spain) or, more commonly, treated with an organic material to make the clay more “organophilic,” i.e., more compatible with systems of low-to-medium polarity (e.g., PANGEL® B20 sepiolite clay from the Tolsa Group). An example of such a coating for fibrous clay is a quaternary ammonium salt such as dimethylbenzylalkylammonium chloride, as disclosed in European Patent Application 221,225.

In an embodiment, the fibrous clay used in the process described herein is unmodified; i.e., the surface of the fibrous clay has not been treated with an organic compound (such as an onium compound, for example, to make its surface less polar). Such onium compounds tend to degrade at the temperatures used to process polyesters such as PBT and some poly(ether-esters).

In an embodiment, the fibrous clay is Theological grade, such as described in European patent applications EP-A-0454222 and EP-A-0170299 and marketed under the trademark Pangel® by Tolsa, S. A., Madrid, Spain. As described therein, “rheological grade” denotes a fibrous clay with a specific surface area greater than 120 m²/g (N₂, BET), and typical fiber dimensions: 200 to 2000 nm long, 10-30 nm wide, and 5-10 nm thick.

Rheological grade sepiolite is obtained from natural sepiolite by means of special micronization processes that substantially prevent breakage of the sepiolite fibers, such that the sepiolite disperses easily in water and other polar liquids, and has an external surface with a high degree of irregularity, a high specific surface, greater than 300 m²/g and a high density of active centers for adsorption, that provide it a very high water retaining capacity upon being capable of forming, with relative ease, hydrogen bridges with the active centers. The microfibrous nature of the rheological grade sepiolite nanoparticles makes sepiolite a material with high porosity and low apparent density.

Additionally, rheological grade sepiolite has a very low cationic exchange capacity (10-20 meq/100 g) and the interaction with electrolytes is very weak, which in turn causes rheological grade sepiolite not to be practically affected by the presence of salts in the medium in which it is found, and therefore, it remains stable in a broad pH range.

The above-mentioned qualities of rheological grade sepiolite can also be attributed to rheological grade attapulgite with particle sizes smaller than 40 micrometers, such as for example the range of ATTAGEL goods (for example ATTAGEL 40 and ATTAGEL 50) manufactured and marketed by the firm Engelhard Corporation, United States, and the MIN-U-GEL range of Floridin Company.

In some embodiments, the amount of fibrous clay used in the process described herein ranges from about 0.1 to about 6 wt % based on the total amount of fibrous clay and polymer in the nanocomposite composition. The specific amount chosen will depend on the intended use of the nanocomposite composition, as is well understood in the art. For example, in film, it may be advantageous to use as little fibrous clay as possible, so as to retain desired optical properties.

### Nanocomposite Preparation

In order to improve the dispersion of the fibrous clay nanoparticles in the polymer matrix, the clay is predispersed in a mixture of about 46% to about 57% wt % water and about 43 to about 54 wt % diol, HO-D-OH. In some embodiments of the process described herein, the amount of fibrous clay is about 0.1 to about 6 wt % wt % based on the combined weight of fibrous clay, water, and diol. In other embodiments of the process described herein, the amount of fibrous clay is about 2.2 to about 5.4 wt % based on the combined weight of fibrous clay, water, and diol. The mixture is agitated by any appropriate method known in the art for preparing suspensions. In one embodiment, the mixture is stirred using a mechanical stirrer and simultaneously refluxed for about 0.5 to about 3 hours and allowed to cool, after which stirring continues for about 10 to 20 hours. After stirring, water is removed, by any appropriate method known in the art, typically distillation, thereby producing a slurry of fibrous clay and diol. Distillation removes approximately 80 to 85% of the water.

The remaining monomer(s) and catalyst are then mixed with the slurry. For poly(ether-ester) nanocomposites, the monomers are the long-chain diol HO-G-OH component, the dicarboxylic acid component, and additional HO-D-OH as needed, the amount depending on how much HO-D-OH was used in the predispersion process versus how much would normally be used for the polymerization reaction; in one embodiment, all of the required HO-D-OH may be added in the predispersion process. For poly(butylene terephthalate) nanocomposites, the monomers are the dicarboxylic acid component, and additional HO-D-OH, the amount depending on how much HO-D-OH was used in the predispersion process versus how much would normally be used for the polymerization reaction; in one embodiment, all of the required HO-D-OH may be added in the predispersion process. Polymerization is then carried out. The pretreatment of the fibrous clay with water/diol results in better dispersion of the nanoparticles in the nanocomposite as compared to material made by a process in which the fibrous clay is added to the monomer mixture in dry powder form.

The polymerization processes are carried out in the presence of predispersed fibrous clay in the same manner as if the clay were absent. In some embodiments of the process described herein, the polymers are prepared by way of an ester interchange reaction, followed by finishing to higher molecular weight. For example, one procedure for making a poly(ether-ester) involves heating the dimethyl ester of the dicarboxylic acid (e.g., dimethyl terephthalate), with the poly(alkylene oxide)glycol (e.g., poly(tetramethylene ether) glycol) and a molar excess of the low molecular weight diol (e.g., 1,4-butanediol), in the presence of a catalyst at 150° C.-160° C., followed by distilling off methanol that is formed by the interchange reaction. Heating is continued until methanol evolution is complete. Depending on temperature, catalyst and glycol excess, this polymerization is complete within a few minutes to a few hours. This product results in the preparation of a low molecular weight material known as a “prepolymer.” Such prepolymers can also be prepared by a number of alternate esterification or ester interchange processes; for example, the long-chain glycol can be reacted with a high or low molecular weight short-chain ester homopolymer or copolymer in the presence of catalyst until randomization occurs. The short-chain ester homopolymer, PBT, can be prepared by ester interchange from either dimethyl terephthalate and 1,4-butanediol as above, or from terephthalic acid with the acetate of 1,4-butanediol.

The resulting prepolymer, whether a poly(ether-ester) or the polyester PBT, is then finished to high molecular weight by distillation of the excess of short-chain diol. This process is known as “polycondensation.” Additional ester interchange occurs during this distillation to increase the molecular weight and to randomize the arrangement of the poly(ether-ester) units. Best results are usually obtained if this final distillation or polycondensation is run at less than 1 mm pressure and 240-260° C. for less than 2 hours in the presence of antioxidants such as 1,6-bis-(3,5-di-tert-butyl-4-hydroxyphenol)propionamido]-hexane or 1,3,5-trimethyl-2,4,6-tris[3,5-d]tertiary-butyl-4-hydroxybenzyl]benzene. Most practical polymerization techniques rely upon ester interchange to complete the polymerization reaction. In order to avoid excessive hold time at high temperatures with possible irreversible thermal degradation, it is advantageous to employ a catalyst for ester interchange reactions.

A wide variety of catalysts can be used. In some embodiments, organic titanates such as tetrabutyl titanate used alone or in combination with magnesium or calcium acetates are used. Complex titanates, such as derived from alkali or alkaline earth metal alkoxides and titanate esters are also very effective. Inorganic titanates, such as lanthanum titanate, calcium acetate/antimony trioxide mixtures and lithium and magnesium alkoxides are representative of other catalysts which can be used.

Ester interchange polymerizations such as those described above are generally run in the melt without added solvent, but inert solvents can be used to facilitate removal of volatile components from the mass at low temperatures. This technique is especially valuable during prepolymer preparation, for example, by direct esterification. Other special polymerization techniques include, for example, interfacial polymerization of bisphenol with bisacylhalides and bisacylhalide capped linear diols, may be useful for preparation of specific polymers. Both batch and continuous methods can be used for any stage of poly(ether-ester) polymer preparation. Polycondensation of prepolymer can also be accomplished in the solid phase by heating finely divided solid prepolymer in a vacuum or in a stream of inert gas to remove liberated low molecular weight diol. This method has the advantage of reducing degradation because it must be used at temperatures below the softening point of the prepolymer. The major disadvantage is the long time required to reach a given degree of polymerization.

Transmission electron microscopy (“TEM”) of nanocomposite samples prepared with predispersed fibrous clay as described herein indicate that predispersion in water plus short-chain diol results in increased dispersion of the exfoliated fibrous clay nanoparticles in the nanocomposite. The treatment with water and diol by itself does not appear to exfoliate the clay, that is, separate fiber bundles or aggregates into nanometer diameter fibers which are then dispersed throughout the polymer matrix. Instead, the predispersion appears to disentangle what appear to be dense nests of fibers. FIG. 1, for example, includes transmission electron micrographs of aliquots of an initial mixture of 50% water, 47.8% 1,4-butanediol, and 3.2% Pangel® S-9 sepiolite clay as prepared (“Before”) and of the slurry of 1,4-butanediol and Pangel® S-9 sepiolite clay with residual water that resulted when the initial mixture was refluxed for two hours, water distilled off, allowed to cool down and stirred the next day for 9 hours (“After”). For preparation of TEM samples, the aliquots were further diluted so that transmission images could be obtained. Both Before and After micrographs show that exfoliated sepiolite fibers are present, but only the Before micrograph indicates the presence of mats of entangled exfoliated sepiolite nanofibers as well.

It is also noted that “melt mixing” or, more precisely, applying shear stress to a melt of the nanocomposite material can result in still better dispersion of the fibrous clay nanoparticles. This melt mixing can be a process simply dedicated to improving the dispersion, or can occur when the polyester composite is liquefied and subject to shear for another reason, such as mixing in other materials and or melt forming the nanocomposite composition. Useful types of apparatuses for this purpose include single and twin screw extruders and kneaders. Examples of other materials that can be melt mixed with the nanocomposite materials described herein include without limitation flame retardants, stabilizers, additional inorganic fillers, tougheners, pigments, plasticizers, and other polymers. Some of these materials may also optionally be present during the polymerization process, such as stabilizers, antioxidants, and other materials sometimes added to such processes. Other filler(s) and/or reinforcing agent(s) may also be present in the polymerization, either from the beginning of the process or added during the process as long as they do not interfere with the polymerization itself.

### Uses

The poly(ether-ester) and poly(butylene terephthalate) nanocomposite materials described herein can be processed easily by conventional thermoplastic processes, including without limitation injection molding, blow molding, calendaring, rotational molding, extrusion, melt casting, melt spinning, and film blowing.

The poly(ether-ester) nanocomposites described herein are especially useful in articles requiring excellent flex fatigue and broad use temperature. Examples include without limitation seals, belts, bushings, pump diaphragms, gears, protective boots, hose and tubing, springs, and impact-absorbing devices. Some of the industries where such parts can be used include the automotive, fluid power, electrical/electronic, appliance and power tool, sporting goods, footwear, wire and cable (including fiber optics), furniture, and off-road transportation equipment industries.

The poly(butylene terephthalate) nanocomposite materials produced by the process described herein can be used in articles for: electrical and electronic applications, such as electrical connectors, plugs, switches, keyboard components, printed circuit boards, and small electric motor components; automotive applications, such as distributor caps, coil-formers, rotors, windshield wiper arms, headlight mountings, and other fittings; industrial machinery, for example in molded conveyor-belt links; medical devices, such as nasal sprays and nebulizers; home appliances, such as food mixers, hair dryers, coffee makers, and toasters; and a variety of other applications, such as fiber-optical cable buffer tubes, countertops, and camera parts. In such applications, the PBT nanocomposite material may be blended with flame retardants or other polymers, for example, polycarbonate and various rubber tougheners.

### EXAMPLES

The process described herein is further defined in the following Examples. It should be understood that these Examples, while indicating embodiments of the invention, are given by way of illustration only. From the above discussion and these Examples, one skilled in the art can ascertain the essential characteristics of the process described herein, and without departing from the spirit and scope thereof, can make various changes and modifications of the process to adapt it to various uses and conditions.

The meaning of abbreviations is as follows: “DMA” means dynamic mechanical analysis, “DPG” means dipropylene glycol, “DSC” means differential scanning calorimetry “g” means gram(s), “GPa” means gigapascal(s), “h” means hour(s), “IV” means intrinsic viscosity, “J” means Joule(s), “mg” means milligram(s), “min” means minute(s), “mL” means milliliter(s), “mm” means millimeter(s), “Mₙ” means number average molecular weight, “MPa” means megapascal(s), “mtorr” means millitorr, “PBT” means poly(butylene terephthalate), “PDI” mean polydispersity index and equals the weight-average molecular weight divided by Mₙ, “rpm” means revolutions per minute, “SEC” means size exclusion chromatography, “TEM” means transmission electron microscopy, “T_{g}” means glass transition temperature, “Tₘ” means melting temperature, and “wt %” means weight percent(age).

### Materials.

Two grades of TERATHANE® polytetramethylene ether glycol (CAS # 25190-06-1), molecular weight 1350-1450 (“PTMEG 1400”) and 1900-2100 (“PTMEG 2000”); and 1,4-butanediol (CAS # 110-63-4, “BDO”) were obtained from INVISTA (Wichita, Kans., USA). Dimethyl terephthalate (CAS# 120-61-6, “DMT,”>99% purity) was purchased from Aldrich Chemical Company (Milwaukee, Wis., USA). Catalyst “Tyzor” TnTBT Titanate (CAS# 5593-70-4, 95-99% purity) was obtained by DuPont. Ciba® Irganox® 1098 antioxidant (CAS# 23128-74-7) was obtained from Ciba (Basel Switzerland). Pangel® S-9, a rheological grade sepiolite clay that has an unmodified surface, was purchased from EM Sullivan Associates, Inc. (Paoli, Pa., USA), a distributor for the manufacturer, Tolsa S.A. (Madrid, Spain).

### Analytical Methods

SEC A size exclusion chromatography (“SEC”) system comprised of a Model Alliance 2690™ from Waters Corporation (Milford, Mass.), with a Waters 410™ refractive index detector (DRI) and Viscotek Corporation (Houston, Tex.) Model T-60A™ dual detector module incorporating static right angle light scattering and differential capillary viscometer detectors was used for molecular weight characterization. The mobile phase was 1,1,1,3,3,3-hexafluoro-2-propanol (HFIP) with 0.01 M sodium trifluoroacetate. The dn/dc was measured for the polymers and it was assumed that all of the sample was completely eluted during the measurement.

### Differential Scanning Calorimetry (“DSC”)

Standardization: The temperature scale was calibrated monthly with the onset melting of three metals: mercury (−38.8° C.), indium (156.6° C.) and tin 231.7° C. (or zinc) at the 10° C./min rate or at the desired heating rate. The calorimetric scale (cell constant) was calibrated in the same time frame using the indium heat of fusion of 28.42 J/g. The Cp constant was calibrated using the vendor suggested procedure.

DSC heat and cool, reheat protocol: 7-10 mg of specimen, crimped in a standard aluminum DSC pan and lid, was heated in a TA Instruments Q1000 or Q2000 DSC at a rate of 10° C./min with the aid of a mechanical cooler for temperature controlling. The starting temperature was generally 30° C. below the T_{g} of the material; the end temperature was set at 30° C. above the last crystal melting temperature. For more than one cycle, the temperature was held at 30° C. above the last crystal melting temperature for 3 minutes; the material was then cooled at a rate of 10° C./min to 0° C., after which the 2nd cycle heating was begun. The glass, melting and crystallization transitions were marked. The crystallinity was calculated after correcting (for the poly(ether-esters)) for the % weight contribution of 50% hard PBT segment and the clay by dividing the total heat of fusion by 72.5 J/g, the heat of fusion of 100% PBT being 145 J/g.

### Dynamic Mechanical Analysis (“DMA”)

Standardization: The clamp calibration was performed whenever the clamp was switched (e.g., tensile to dual cantilever), including the weight of movable clamp, offset and compliance. The temperature scale was calibrated once using a special device for penetrating a needle into indium metal at 156.6° C.; and again by the loss modulus of the peak temperature of the glass transition at 1 Hz of a sample of Lexan® polycarbonate [formerly a trademark of General Electric, now owned by Saudi Basic Industries Corp., Riyadh, Saudi Arabia]. The modulus check used the storage modulus of the same polycarbonate at 25° C. of 2.25 GPa+/−10%.

DMA standard single ramp protocol: The specimen was mounted in the DMA jaws with 10 in-lb torque in the appropriate clamp assembly, e.g., 35 mm or 20 mm or 8 mm, depending on the thickness of specimen allowing the closest 10:1 of length to thickness rule. The specimen was cooled with the aid of a gas cooling accessory to −100° C. and the specimen re-torqued in the jaws. The specimen was then heated at 2° C./min at 6 frequencies (1, 3, 5, 10, 20, 50 Hz) to a temperature below the melting point (e.g., 150° C.) at 10 μm oscillation amplitude. The modulus of interest and transition temperature were marked.

### Cryoultramicrotomy and TEM Imaging of Nanocomposite Compositions

To prepare ultrathin specimens for transmission electron microscopy (“TEM”), a diamond knife was used to cut sample sections by low temperature ultramicrotomy. The knife boat used to accumulate sections was filled with absolute ethanol to prevent freezing at the −90° C. operating temperature. A specimen block was trimmed with single edge razor blades. The block was secured in the flat jaws of the cryoultramicrotome sample holder and sectioned to a nominal thickness of 90 nm. After sectioning was complete, the boat fluid with the sample sections was poured into a shallow dish of water. The sections floated on the water/alcohol mixture and were retrieved on copper mesh grids, and blotted on filter paper. The sectioning procedure should be carried out by one skilled in the art.

Unstained sections were examined in a Transmission Electron Microscope (TEM) operated at 200 KV accelerating voltage. Images of magnification 1000-85,000× were recorded on a digital camera. Sampling of both well dispersed, individual rodlike nanoparticles of sepiolite and poorly dispersed clumps of mineral above 1 micron in diameter were documented. The imaging procedure should be carried out by one skilled in the art.

### NMR

The dipropylene glycol (DPG) content (wt %) in poly(trimethylene terephthalate) was determined using ¹H NMR.

### Example 1

This example illustrates the preparation of a nanocomposite of exfoliated sepiolite nanoparticles in a matrix of a poly(ether-ester) (“PEE-1”), where the sepiolite nanoparticles are predispersed in a diol/water mixture.

Sepiolite clay (Pangel® S-9, 4.1 g), water (60.2 g) and 1,4-butanediol (45.01 g, 0.499 mol) were added to a 450 mL resin kettle. The contents were refluxed for 50 min while mixture was agitated with a mechanical stirrer. The mixture was allowed to cool down and stirred overnight. The next day, water was distilled off, and 50.14 g of water fraction was recovered in the distillate, leaving behind a slurry of sepiolite clay in 1,4-butanediol with some remnant water. To this slurry, PTMEG 1400 (65.07 g, approx. 0.046 mol), 1,4-butanediol (13.15 g, 0.146 mol), dimethyl terephthalate (60.46 g, 0.312 mol), and 0.39 g of Irganox® 1098 antioxidant were added to create a reaction mixture. An overhead stirrer was attached and a distillation condenser was attached. The reaction mixture was evacuated to 0.5 torr and refilled with N₂ gas; this process was followed three more times. After the first evacuation step, 2.4 mL of catalyst Tyzor®TnTBT stock solution (5 wt % catalyst solution in 1,4-butanediol) was added to the reaction mixture under a nitrogen blanket. The reaction was heated to 160° C. under a light nitrogen flush. The stirrer speed was maintained at 3 rpm and the solids were allowed to melt completely at 160° C. After 20 minutes, the temperature was increased to 210° C., and the stirrer speed was increased to 50 rpm. The temperature was maintained at 210° C. for 40 minutes. Finally, the temperature was increased to 260° C. and was held constant for 10 min. The nitrogen flush was closed off and a vacuum ramp was started. After 20 min, the vacuum reached a value of 145 mtorr. The reaction mixture was maintained under vacuum for 50 min. The properties of the polymer matrix of the resulting nanocomposite were determined as described above: Mₙ=21600, PDI=2.63, IV=1.7, T_{g}=−69° C., Tₘ=195° C., and percent crystallinity=44%. The nanocomposite material so produced, nominally containing 3 wt % sepiolite, was characterized using TEM, which showed the sepiolite nanoparticles to be fairly well dispersed in the poly(ether-ester) (FIG. 2). Both images shown, at two different magnifications, revealed a high density of singly dispersed sepiolite nanoparticles along with the presence of few agglomerates.

### Example 2

This example illustrates the effect of extrusion on sepiolite dispersion in a PEE-1/sepiolite nanocomposite that had been prepared with predispersion of sepiolite nanoparticles in a diol/water mixture.

The PEE-1/sepiolite nanocomposite prepared in Example 1 was extruded using a DSM mini twin screw extruder set at 220° C. and 50 rpm. The material was charged to the extruder under a nitrogen blanket. After charging of the material, the speed was increased to 100 rpm. After about 2-5 minutes, the material was transferred into a transfer cylinder maintained at 21° C., followed by transfer into a mold set at 45° C. The dispersion was further improved versus the as-made nanocomposite, as shown in FIG. 3, a bright field TEM micrograph of the extruded nanocomposite. The image shows the presence of individually dispersed sepiolite nanoparticles.

### Comparative Example A

This experiment illustrates the lesser amount of sepiolite dispersion achieved in a PEE-1/sepiolite when the sepiolite nanoparticles are not predispersed in a diol/water mixture.

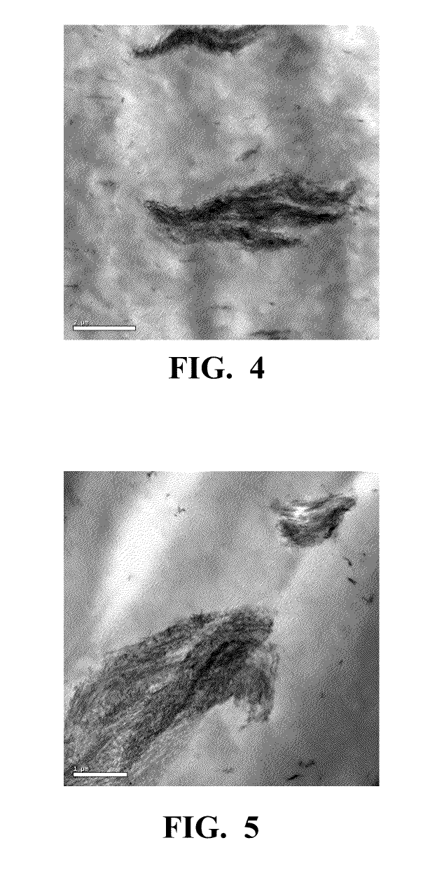

PTMEG 1400 (65.07 g, approx. 0.046 mol), 1,4-butanediol (56.16 g, 0.623 mol), dimethyl terephthalate (60.46 g, 0.312 mol), Irganox® 1098 antioxidant (0.39 g), and sepiolite clay (Pangel® S-9, 4.1 g) were added to a 450 mL resin kettle to create a reaction mixture. An overhead stirrer and a distillation condenser were attached. The reaction mixture was evacuated to 0.5 torr and refilled with N₂ gas; this process was followed three more times. After the first evacuation step, 2.4 mL of catalyst Tyzor® TnTBT stock solution (5 wt % catalyst solution in 1,4-butanediol) was added to the reaction mixture under a nitrogen blanket. The reaction mixture was heated to 160° C. under a light nitrogen flush. The stirrer speed was maintained at 3 rpm and the solids were allowed to completely melt at 160° C. After 20 minutes, the temperature was increased to 210° C. and the stirrer speed was increased to 50 rpm. The system was maintained at 210° C. for 40 minutes. Finally, the temperature was increased to 260° C. and was held constant for 10 min. The nitrogen flush was closed off and vacuum ramp was started. After 25 min, the vacuum reached a value of 58 mtorr. The reaction mixture was maintained under vacuum for approximately 75 min. The properties of the polymer matrix of the resulting nanocomposite were determined as described above: Mₙ=34910, PDI=1.88, IV=2.0, T_{g}=−72° C., Tₘ=200° C., and percent crystallinity=39%. The nanocomposite material so produced, nominally containing 3 wt % sepiolite, was characterized using TEM, which showed the sepiolite nanoparticles to be poorly dispersed in the polymer, as shown in FIG. 4, a bright field TEM micrograph of an as-made sample of the PEE-1/sepiolite nanocomposite. The polymer matrix appears as the bright phase and sepiolite as the dark. The image shows the presence of sepiolite agglomerates and few individual nanoparticles.

The as-made PEE-1/sepiolite nanocomposite sample was further subjected to extrusion in the DSM mini extruder to improve the dispersion quality by utilization of mechanical shear stress offered by the screws. The DSM mini twin extruder was set at 220° C. and 50 rpm. The material was charged to the extruder under a nitrogen blanket. After charging of the material, the speed was increased to 100 rpm. After about 2-5 minutes, the material was transferred into a transfer cylinder maintained at 210° C., followed by which it was transferred into a mold set at 45° C. The extruded material was then characterized by TEM to evaluate the dispersion quality. FIG. 5, a bright field TEM micrograph of the extruded material shows the presence of sepiolite agglomerates in the polymer matrix, without much increase in the density of individually dispersed nanoparticles versus the unextruded material shown in FIG. 4.

### Example 3

This example demonstrates the effect of predispersing sepiolite in a diol/water mixture on the modulus of PEE-1/sepiolite nanocomposites as a function of temperature.

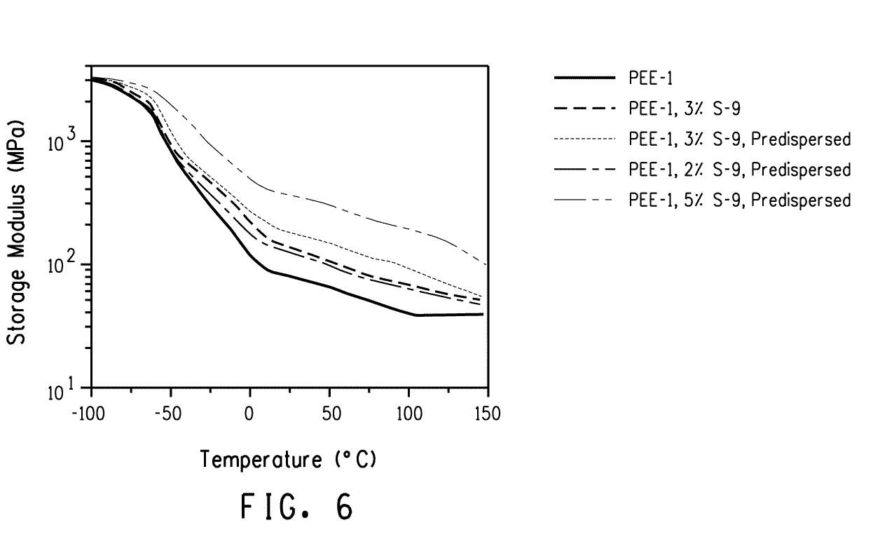

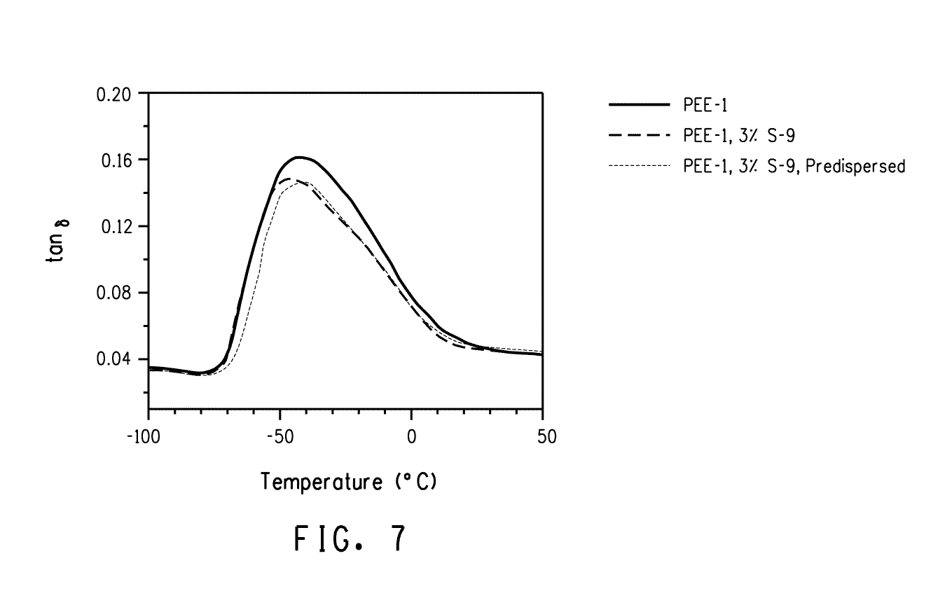

Dynamic Mechanical Analysis (“DMA”) was used as described above over a wide temperature range to determine the storage modulus (E′, energy stored elastically during deformation) and tan δ (loss tangent=the ratio of storage modulus E′ to loss modulus E″, where the loss modulus is the energy converted to heat during deformation) of the PEE-1/sepiolite nanocomposites prepared in Example 1 and Comparative Example A above, i.e., with and without the predispersing the sepiolite nanoparticles in a diol/water mixture, containing nominally 3 wt % sepiolite (Pangel® S-9) and of a control sample of the poly(ether-ester) PEE-1, polymerized as described in Example 1 but without sepiolite. Results are presented in FIGS. 6 and 7.

In FIG. 6, it can be observed that both in-situ polymerized PEE-1/sepiolite nanocomposites composites containing nominally 3% sepiolite were stiffer than the PEE-1 control. However, the nanocomposite which was prepared including the predispersion process showed higher storage modulus over the temperature range studied, −100° C. to +150° C., than the nanocomposite prepared without predispersing the sepiolite nanoparticles in a diol/water mixture.

Improved filler dispersion is indicated in the nanocomposite which was prepared including the predispersion process by the change in position of the tan δ peak (FIG. 7). The onset of T_{g} was increased by at least 4° C. in the nanocomposite prepared with sepiolite nanoparticles that had been predispersed in a diol/water mixture. This is consistent with the TEM observations, since it implies that the polymer had more highly restricted chain mobility because of increased sepiolite dispersion.

### Example 4

This example demonstrates the effect of sepiolite content and predispersing the sepiolite nanoparticles in a diol/water mixture on the modulus of PEE-1/sepiolite nanocomposites.

PEE-1/sepiolite nanocomposites containing nominally 2 wt % and 5 wt % sepiolite (Pangel® S-9) were prepared as described in Example 1. The molecular weight build up in the polymerization in the case of the 2 wt % sepiolite nanocomposite was satisfactory; however, the one with 5% did not show as much increase in torque, indicating a lower molecular weight of PEE-1 was achieved. DMA results are presented in FIG. 6 for these materials, the nanocomposites prepared in Example 1 and Comparative Example A, and the PEE-1 (no sepiolite) control. Modulus increased with increasing sepiolite content for nanocomposites prepared including predispersion in a diol/water mixture. In addition, the sample containing nominally 2 wt % sepiolite and prepared including predispersion in a diol/water mixture has almost as high modulus over the experimental temperature range as the nominally 3 wt % sepiolite nanocomposite made without diol/water predispersion.

### Example 5

This example illustrates the preparation of a nanocomposite of exfoliated sepiolite nanoparticles in a matrix of a different poly(ether-ester) (“PEE-2”), in which the sepiolite nanoparticles are predispersed in a diol/water mixture. PEE-2 contains a higher proportion of PTMEG than PEE-1, resulting in a polymer with lower modulus.

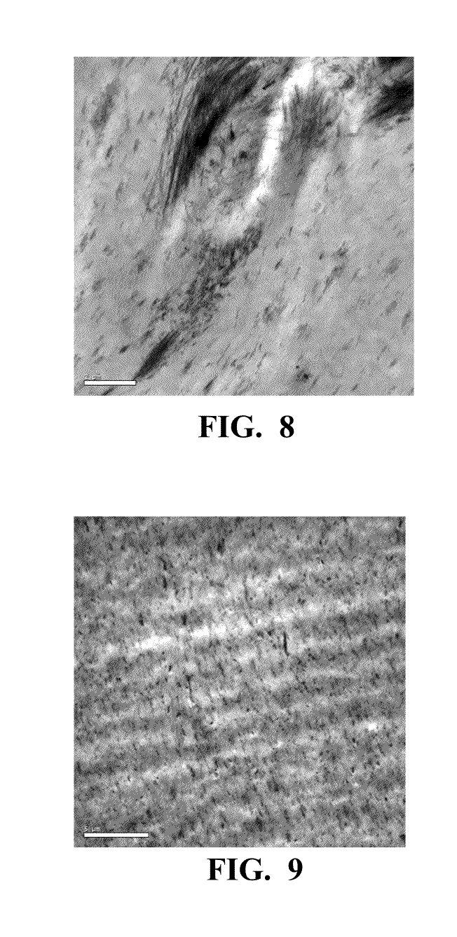

Sepiolite clay (Pangel® S-9, 3 g), 45 g of water and 1,4-butanediol (42.00 g, 0.466 mol) were added to a 450 mL resin kettle. The contents were refluxed for 2 h while mixture was agitated with a mechanical stirrer. Water was distilled off, and 37.15 g of water fraction was recovered in the distillate, leaving behind a slurry of sepiolite clay in 1,4-butanediol with some remnant water. To this dispersion PTMEG 2000 (60.16 g, approx. 0.03 mol), dimethyl terephthalate (37.0 g, 0.191 mol), and 0.3 g of Irganox® 1098 antioxidant were added to form a reaction mixture. An overhead stirrer and a distillation condenser were attached. The reaction mixture was evacuated to 0.5 torr and refilled with N2 gas; this process was followed three more times. After the first evacuation step, 3.4 mL of catalyst Tyzor®TnTBT stock solution (5 wt % catalyst solution in 1,4-butanediol) was added to the reaction mixture under a nitrogen blanket. The reaction mixture was heated to 160° C. under a light nitrogen flush. The stirrer speed was maintained at 5 rpm and the solids were allowed to completely melt at 160° C. After 20 minutes, the temperature was increased to 210° C. and the stirrer speed was increased to 50 rpm. The system was maintained at 210° C. for 40 minutes. Finally, the temperature was increased to 260° C. and was held constant for 10 min. The nitrogen flush was closed off and vacuum ramp was started. After 20 min, the vacuum reached a value of 100 mtorr. The reaction mixture was maintained under vacuum for 30 min. The properties of the polymer matrix of the resulting nanocomposite were determined as described above: Mₙ=38800, PDI=2.63, IV=3.05, Tₘ=191° C., and percent crystallinity=34%. The nanocomposite material so produced was characterized using TEM, which showed the sepiolite nanoparticles to be fairly well dispersed in the polymer. FIG. 8 is a bright field TEM micrograph of the as-made sample. The image reveals singly dispersed sepiolite nanoparticles along with the presence of few agglomerates.

### Example 6

This example illustrates the effect of extrusion on sepiolite dispersion in a PEE-2/sepiolite nanocomposite whose preparation included predispersing the sepiolite nanoparticles in a diol/water mixture.

The PEE-2/sepiolite nanocomposite prepared in Example 5 was extruded using a twin screw extruder set at 220° C. and 50-100 rpm. The dispersion was further improved as shown in FIG. 9, a bright field TEM micrograph of the extruded nanocomposite. The image shows the presence of individually dispersed sepiolite nanoparticles.

### Comparative Example B

This experiment illustrates the lesser amount of sepiolite dispersion achieved in a PEE-2/sepiolite when the sepiolite nanoparticles are not predispersed in a diol/water mixture.

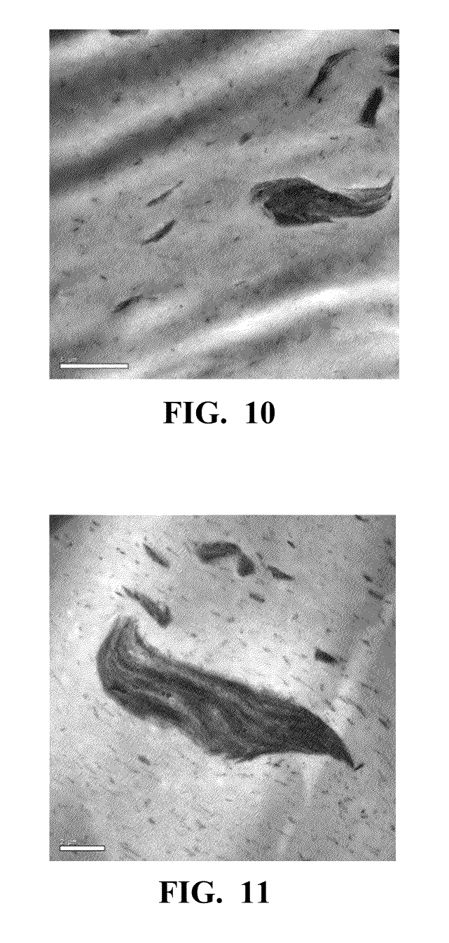

Sepiolite clay (Pangel® S-9, 3 g), and 1,4-butanediol (42.00 g, 0.466 mol) were added to a 450 mL resin kettle. The contents were allowed to stir overnight at 40° C. at 60 rpm with a mechanical stirrer. To this dispersion PTMEG 2000 (60.16 g, approx. 0.03 mol), dimethyl terephthalate (37.0 g, 0.191 mol), and 0.3 g of Irganox® 1098 antioxidant were added to form a reaction mixture. An overhead stirrer and a distillation condenser were attached. The reaction mixture was evacuated to 0.5 torr and refilled with N₂ gas; this process was followed three more times. After the first evacuation step, 3.0 mL of catalyst Tyzor®TnTBT stock solution (5 wt % catalyst solution in 1,4-butanediol) was added to the reaction mixture under a nitrogen blanket. The reaction mixture was heated to 160° C. under a light nitrogen flush. The stirrer speed was maintained at 5 rpm and the solids were allowed to completely melt at 160° C. After 20 minutes, the temperature was increased to 210° C. and the stirrer speed was increased to 50 rpm. The system was maintained at 210° C. for 40 minutes. Finally, the temperature was increased to 260° C. and was held constant for 10 min. The nitrogen flush was closed off and vacuum ramp was started. After 18 min, the vacuum reached a value of 200 mtorr. The reaction mixture was maintained under vacuum for 60 min. The properties of the polymer matrix of the resulting nanocomposite were determined as described above: Mₙ=31780, PDI=2.38, IV=2.55, Tₘ=191° C., and percent crystallinity=30%. The nanocomposite material so produced was characterized using TEM, which showed the sepiolite to be poorly dispersed in the polymer. FIG. 10 is a bright field TEM micrograph of the nanocomposite material. The polymer matrix appears as the bright phase and sepiolite as the dark. The image shows the presence of sepiolite agglomerates and few individually dispersed nanoparticles.

The as-made nanocomposite sample was further subjected to extrusion in the DSM mini extruder set at 220° C. and between 50-100 rpm to improve the dispersion quality by utilization of mechanical shear stress offered by the screws. The material was characterized by TEM again to evaluate the dispersion quality. FIG. 11 is a bright field TEM micrograph of the extruded nanocomposite. The image shows that sepiolite agglomerates persist in the polymer matrix, with a slight increase in the density of individually dispersed nanoparticles.

The mechanical property data is summarized below in Table 1 for extruded materials which were molded into mini tensile bars. The number in parentheses is the measurement's standard deviation.

TABLE 1

Secant Modulus at 10%
Strain (MPa)

| Sample | Description | 23° C. | 110° C. |
|---|---|---|---|
| Control | PEE-2 (no sepiolite) | 28.6 (6.4) | 17.5 (1.2) |
| Comparative | PEE-2/3% sepiolite | 44.4 (4.4) | 24.4 (2.2) |
| Example B | nanocomposite | | |
| | (Comp. Ex. B) | | |
| Example 5 | PEE-2/3% sepiolite | 51.5 (2.2) | 30.8 (1.9) |
| | nanocomposite | | |
| | (water/BDO | | |
| | predispersion) | | |

### Example 7

This examples illustrates the preparation of a control sample of neat PBT and a PBT/sepiolite nanocomposite using predispersion of the sepiolite nanoparticles in 1,4-butanediol.

### Neat PBT Control

Dimethyl terephthalate (88.23 g, 0.45 mol), and 1,4-butanediol (68.08 g, 0.75 mol) were charged to a 500 mL three necked round bottom flask to form a reaction mixture. An overhead stirrer and a distillation condenser were attached. The reaction mixture was stirred at a speed of 10 rpm. The reaction mixture was kept under a N₂ purge atmosphere. The contents were degassed four times by evacuating down to 500 mtorr and refilling back with N₂ gas. After the first evacuation step, 1.54 mL of catalyst Tyzor®TnTBT stock solution (5 wt % catalyst solution in 1,4-butanediol) was added to the reaction mixture under a nitrogen blanket. The reaction mixture was heated to 150° C. under a light nitrogen flush. The solids were allowed to melt completely at 150° C. After 20 minutes, the temperature was increased to 225° C., and the stirrer speed was increased to 180 rpm. The system was maintained at 225° C. for 40 minutes to distill off most of the methanol. The nitrogen flush was then closed off, vacuum ramp was started, and the temperature was simultaneously increased to 250° C. at 1.5° C./min. After 25 min, the vacuum reached a value of 75 mtorr. The reaction mixture was maintained under vacuum for approximately 45 min. The properties of the polymer so produced were determined as described above: Mₙ=32000, PDI=2.22, T_{g}=53° C., Tₘ=224° C., and percent crystallinity=37.7%.

PBT with Predispersed Sepiolite Nanoparticles

Sepiolite clay (Pangel® S-9, 3.0 g), 60.0 g of water and 1,4-butanediol (66.0 g, 0.73 mol) were added to a 500 mL three necked round bottom flask. The contents were refluxed for 2 h while the mixture was agitated with a mechanical stirrer. Water was distilled off, leaving behind a slurry of sepiolite clay in 1,4-butanediol with some remnant water. The mixture was allowed to cool down to 40° C. and stirred over a weekend. To this dispersion, additional 1,4-butanediol (2.08 g, 0.023 mol), and dimethyl terephthalate (88.23 g, 0.45 mol) were added to form a reaction mixture. An overhead stirrer and a distillation condenser were attached. The reaction mixture was evacuated to 0.5 torr and refilled back with N₂ gas; this process was followed three more times. After the first evacuation step, 1.54 mL of catalyst Tyzor®TnTBT stock solution (5 wt % catalyst solution in 1,4-butanediol) was added to the reaction mixture under a nitrogen blanket. The reaction mixture was heated to 160° C. under a light nitrogen flush. The stirrer speed was maintained at 10 rpm, and the solids were allowed to melt completely at 160° C. After 20 minutes, the temperature was increased to 225° C. and the stirrer speed was increased to 180 rpm over a period of 10 minutes. Methanol was allowed to distill off. The nitrogen flush was then closed off, the vacuum ramp was started, and the temperature was simultaneously increased to 250° C. at 1.5° C./min. After 46 min, the vacuum reached a value of 95 mtorr. The reaction mixture was maintained under vacuum for 36 min. The properties of the polymer matrix of the resulting nanocomposite were determined as described above: Mₙ=29900, PDI=2.18, T_{g}=54° C., Tₘ=223° C., and percent crystallinity=37.3%.

### COMPARATIVE EXAMPLE C

This experiment illustrates the lesser properties of a PBT/sepiolite nanocomposite prepared without predispersing the sepiolite nanoparticles in a mixture of water and 1,4-butanediol.

Dimethyl terephthalate (88.67 g, 0.46 mol), 1,4-butanediol (68.08 g, 0.75 mol), and sepiolite clay (Pangel® S-9, 3.0 g) were charged to a 500 mL three necked round bottom flask. An overhead stirrer and a distillation condenser were attached. The reactants were stirred at a speed of 10 rpm. The reaction mass was kept under N₂ purge atmosphere. The contents were degassed four times by evacuating down to 500 mtorr and refilling back with N₂ gas. After the first evacuation step, 1.54 mL of catalyst Tyzor®TnTBT stock solution (5 wt % catalyst solution in 1,4-butanediol) was added to the reaction mixture under a nitrogen blanket. The reaction was heated to 145° C. under a light nitrogen flush. The solids were allowed to melt completely at 145° C. After 20 minutes, the temperature was increased to 225° C. and the stirrer speed was increased to 50 rpm. The system was maintained at 225° C. to distill off most of the methanol. The nitrogen flush was closed off, vacuum ramp was started, the temperature was simultaneously increased to 250° C. at 1.5° C./min, and the stirrer speed was increased to 180 rpm. After 30 min, the vacuum reached a value of 96 mtorr. The reaction mixture was maintained under vacuum for approximately 40 min. The properties of the polymer matrix of the resulting nanocomposite were determined as described above: Mₙ=26900, PDI=2.39, T_{g}=54° C., Tₘ=223° C., and percent crystallinity=37.2%.

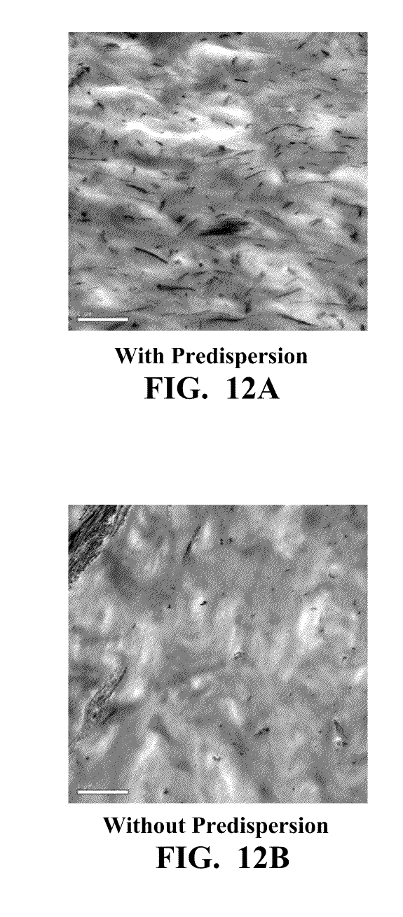

Bright field TEM micrographs of the PBT/sepiolite clay nanocomposites prepared in Example 7 and Comparative Example C are presented in FIG. 12. The Comparative Example C TEM shows the presence of agglomerates and few individual nanoparticles, while the Example 7 TEM shows a higher density of singly dispersed sepiolite nanoparticles along with the presence of few agglomerates, indicating that predispersing the sepiolite nanoparticles in water and 1,4-butanediol improved dispersion quality.

The flexural (“flex”) modulus of molded bars of the materials prepared in Example 7 and Comparative Example C are presented in Table 2. The samples have similar modulus at room temperature. and the sepiolite-containing materials have higher flexural modulus at elevated temperatures than the neat PBT. The samples prepared using sepiolite nanoparticles predispersed in water and 1,4-butanediol have the highest high-temperature flexural modulus of the samples tested.

TABLE 2

| | | Flex Modulus | Flex Modulus | Flex Modulus |
|---|---|---|---|---|
| Sample | Description | (MPa) 25° C. | (MPa) 100° C. | (MPa) 150° C. |
| Control | Neat PBT | 1926 | 250.6 | 127 |
| Comparative | PBT/sepiolite | 1879 | 313.8 | 196.3 |
| Example C | | | (25.2% increase) | (54.5% increase) |
| Example 7 | PBT/sepiolite, | 1880 | 324.7 | 201.7 |
| | predispersed | | (29.6% increase) | (58.8% increase) |

Comparative Examples D and E demonstrate that predispersion of sepiolite in a diol/water mixture improves properties of PBT/sepiolite nanocomposites, it does not do so in poly(ethylene terephthalate)/sepiolite nanocomposites nor in poly(trimethylene terephthalate)/sepiolite nanocomposites.

### Comparative Example D

This Comparative Example illustrates the lack of property improvement in a poly(trimethylene terephthalate)/sepiolite nanocomposite prepared with predispersing the sepiolite nanoparticles in a mixture of water and 1,3-propanediol versus preparation without predispersion.

### Neat Poly(Trimethylene Terephthalate) Control

Dimethyl terephthalate (88.23 g, 0.45 mol), and 1,3-propanediol (68.08 g, 0.89 mol), were charged to a 500 mL three necked round bottom flask to form a reaction mixture. An overhead stirrer and a distillation condenser were attached. The reaction mixture was stirred at a speed of 15 rpm. The reaction mixture was kept under a N₂ purge atmosphere. The reaction mixture was degassed three times by evacuating down to 500 mtorr and refilling back with N₂ gas. The round bottom flask was immersed in a preheated metal bath set at 160° C. The solids were allowed to melt completely at 160° C. Catalyst Tyzor®TnTPT (0.03 g, 9.8×10⁻⁵ mol) was added under a N₂ blanket. The temperature was increased to 210° C. and the stirrer speed was increased to 180 rpm. The system was maintained at 210° C. to distill off most of the methanol. The nitrogen flush was closed off, vacuum ramp was started, and the temperature was simultaneously increased to 250° C. After 22 min, the vacuum reached a value of 92 mtorr. The reaction mixture was maintained under vacuum for approximately 2 h and 30 min. The properties of the polymer so produced were determined as described above: Mₙ=22000, PDI=2.28, T_{g}=55.1° C., Tₘ=230° C., and percent crystallinity=38.9%, DPG level=trace.

Poly(Trimethylene Terephthalate)/Sepiolite Nanocomposite, without Predispersion of Sepiolite Nanoparticles

Dimethyl terephthalate (69.21 g, 0.36 mol), 1,3-propanediol (94.16 g, 1.24 mol), sepiolite clay (Pangel® S-9, 3.0 g) were charged to a 500 mL three necked round bottom flask to form a reaction mixture. An overhead stirrer and a distillation condenser were attached. The reaction mixture was stirred at a speed of 15 rpm. The reaction mixture was kept under N₂ purge atmosphere. The reaction mixture was degassed two times by evacuating down to 500 mtorr and refilling back with N₂ gas. The round bottom flask was immersed in a preheated metal bath set at 160° C. The solids were allowed to melt completely at 160° C. Catalyst Tyzor®TnTPT (0.03 g in 2 g of 1,3-propanediol) was added under a N₂ blanket. The temperature was increased to 210° C. and the stirrer speed was increased to 180 rpm. The system was maintained at 210° C. for 40-50 minutes to distill off most of the methanol. Finally, the temperature was increased to 250° C. and was held constant for 10 min. The nitrogen flush was closed off and vacuum ramp was started. After 33 min, the vacuum reached a value of 230 mtorr. The reaction mixture was maintained under vacuum for approximately 2 hours. The properties of the polymer matrix of the resulting nanocomposite were determined as described above: Mₙ=19160, PDI=2.28, T_{g}=55.7° C., T m=226° C., percent crystallinity as determined by cooling cycle=40%, and DPG level=2.91%

Poly(Trimethylene Terephthalate)/Sepiolite Nanocomposite, with Predispersed Nanoparticles

Sepiolite clay (Pangel® S-9, 3.0 g), 60.0 g of water and 1,3-Propanediol (94.16 g, 1.24 mol) were added to a 500 mL three necked round bottom flask. The contents were refluxed for 2 h while the mixture was agitated with a mechanical stirrer. Water was distilled off, leaving behind a slurry of sepiolite clay in 1,3-propanediol with some remnant water. The slurry was allowed to cool down to room temperature stirred over night. To this slurry, dimethyl terephthalate (94.16 g, 0.48 mol) was added to form a reaction mixture. An overhead stirrer and a distillation condenser were attached. The reaction mixture was stirred at a speed of 15 rpm. The reaction mixture was kept under a N₂ purge atmosphere. The reaction mixture was degassed two times by evacuating down to 500 mtorr and refilling back with N₂ gas. The round bottom flask was immersed in a preheated metal bath set at 160° C. The solids were allowed to melt completely at 160° C. Catalyst Tyzor®TnTPT (0.03 g, 9.8×10⁻⁵ mol) was added under a N₂ blanket. The temperature was increased to 210° C. and the stirrer speed was increased to 180 rpm. The system was maintained at 210° C. to distill off most of the methanol. Finally, the temperature was increased to 250° C. and was held constant for 10 min. The nitrogen flush was closed off and vacuum ramp was started. After 22 min, the vacuum reached a value of 130 mtorr. The reaction mixture was maintained under vacuum for approximately 2 hours. The properties of the polymer matrix of the resulting nanocomposite were determined as described above: Mₙ=18300, PDI=2.24, T_{g}=56.2° C., Tₘ=227.2° C., percent crystallinity=33.3%, and DPG level=1.7%

Transmission electron microscopy of the poly(trimethylene terephthalate)/sepiolite nanocomposites indicated that the dispersion quality of the sepiolite nanoparticles was unaffected by predispersing the sepiolite in the 1,3-propanediol/water mixture. Crystallization half-time measurements indicated that sepiolite nanoparticles acted as a nucleating agent in both nanocomposites and but was more effective as a nucleating agent when not predispersed.

### Comparative Example E

This Comparative Example illustrates the lack of property improvement in a poly(ethylene terephthalate)/sepiolite nanocomposite prepared with predispersing the sepiolite nanoparticles in a mixture of water and ethylene glycol versus preparation without predispersion.

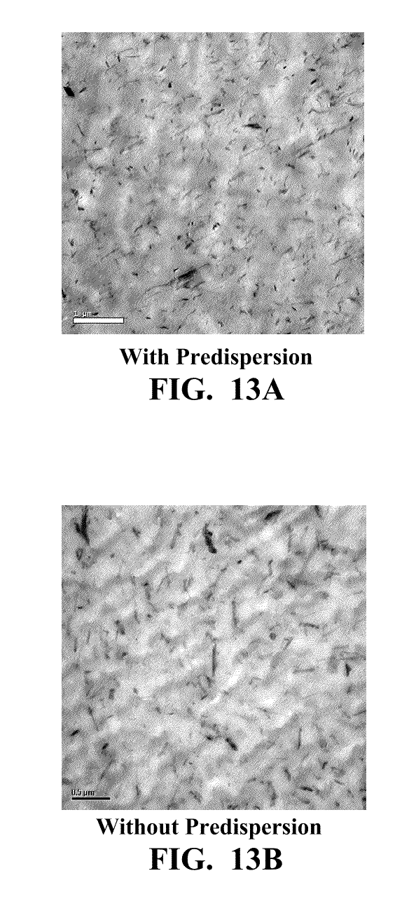

Sepiolite clay (Pangel® S-9, 2.88 g), 65.0 g of water and ethylene glycol (50.0 g, 0.8 mol) were added to a 500 mL three necked round bottom flask. The contents were refluxed for 2 h while the mixture was agitated with a mechanical stirrer. Water was distilled off, leaving behind a slurry of sepiolite clay in ethylene glycol with some remnant water. The slurry was allowed to cool down to room temperature and stirred overnight. To this slurry, dimethyl terephthalate (97 g, 0.5 mol), manganese acetate (0.045 g, 0.00026 mol), and antimony oxide (0.075 g, 0.00026 mol) were added to form a reaction mixture. An overhead stirrer and a distillation condenser were attached. The reaction mixture was stirred at a speed of 10 rpm. The reaction mixture was kept under a N₂ purge atmosphere. The contents were degassed two times by evacuating down to 500 mtorr and refilling back with N₂ gas. The round bottom flask was immersed in a preheated metal bath set at 190° C. The stirrer speed was increased to 180 rpm. The temperature was increased to 290° C. at 1.5° C./min after 90 minutes. The temperature was lowered and an additional 55 g of ethylene glycol was added to the reactor. The temperature was raised back up to 290° C. in steps. The nitrogen flush was closed off and vacuum ramp was started. After 30 min, the vacuum reached a value of 298 mtorr. The reaction mixture was maintained under vacuum for 30 min. Transmission electron microscopy of the nanocomposite material thereby produced showed no change in dispersion quality of the sepiolite nanoparticles when compared with the TEM of a sample similarly prepared but without predispersing the sepiolite nanoparticles in water plus ethylene glycol (FIG. 13)

1. A method for dispersing exfoliated fibrous clay nanoparticles in a poly(ether-ester) having a multiplicity of recurring long-chain ester units and short-chain ester units joined head-to-tail through ester linkages, said long-chain ester units being represented by Formula I 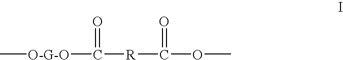
and said short-chain ester units being represented by Formula II 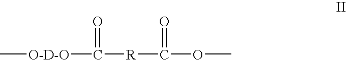
wherein G is a divalent radical remaining after the removal of terminal hydroxyl groups from a poly(alkylene oxide)glycol having an average molecular weight of about 400-3500;
R is a divalent radical remaining after removal of carboxyl groups from a dicarboxylic acid having a molecular weight less than about 300; and
D is a divalent radical remaining after removal of hydroxyl groups from a diol having a molecular weight less than about 250;
wherein said poly(ether-ester) contains from about 25 to about 90 weight percent short-chain ester units, based upon the total weight of the poly(ether-ester), comprising:
a. providing a mixture of exfoliated fibrous clay nanoparticles, HO-D-OH and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in HO-D-OH and the remaining water;
d. preparing a reaction mixture by mixing the slurry produced in (c) with polyalkylene glycol OH-G-OH; the dicarboxylic acid 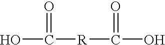
or the dimethyl ester thereof, 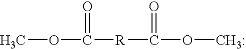
and additional HO-D-OH as needed for the polymerization; and
e. polymerizing the reaction mixture prepared in (d) in the presence of a catalyst.

2. The method of claim 1 wherein HO-G-OH is selected from the group consisting of poly(ethylene ether) glycol, poly(tetramethylene ether) glycol, poly(tetramethylene-co-2-methyltetramethylene ether), poly(ethylene-co-tetramethylene ether) glycol, and mixtures thereof.

3. The method of claim 1 wherein HO-D-OH is selected from the group consisting of ethylene glycol, 1,3 propane diol, 1,4-butanediol, 2,2-dimethyl-1,3-propylene diol, and mixtures thereof.

4. The method of claim 1 wherein R is p-phenylene or a mixture of p-phenylene and m-phenylene.

5. The method of claim 1 wherein the amount of water in step (a) is about 46 wt % to about 57% wt % based on the weight of water plus diol, HO-D-OH.

6. The method of claim 1 wherein the amount of fibrous clay in step (a) is about 0.1 to about 6.0 wt % based on the combined weight of fibrous clay, water, and diol.

7. A method for dispersing exfoliated fibrous clay nanoparticles in poly(butylene terephthalate), 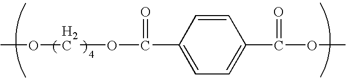
comprising
a. providing a mixture of exfoliated fibrous clay nanoparticles, 1,4-butanediol and water;
b. agitating the mixture for a time sufficient to fully disperse the exfoliated fibrous clay nanoparticles in the mixture;
c. removing at least 80% of the water, thereby producing a slurry of exfoliated fibrous clay nanoparticles dispersed in 1,4-butanediol and the remaining water;
d. preparing a reaction mixture by mixing the slurry produced in (c) with dimethyl terephthalate or terephthalic acid and with additional 1,4-butanediol as needed for the polymerization; and
e. polymerizing the reaction mixture prepared in (d) in the presence of a catalyst.

8. The method of claim 7 wherein the amount of water in step (a) is about 46 wt % to about 57% wt % based on the weight of water plus 1,4-butanediol.

9. The method of claim 7 wherein the amount of fibrous clay in step (a) is about 0.1 to about 6.0 wt % based on the combined weight of fibrous clay, water, and 1,4-butanediol.
